(19) United States
(12) Patent Application Publication
(10) Pub. No.: US 2024/0238916 A1
(43) Pub. Date: Jul. 18, 2024

(54) SLAT SYSTEM AND METHOD FOR A LASER CUTTER WORK SURFACE

(71) Applicant: Connaughty Industries, Inc., dba Rushford Manufacturing, Rushford, MN (US)

(72) Inventors: Jay Thomas Hisel, Lansing, IA (US); Kenneth Gene Connaughty, Peterson, MN (US)

(73) Assignee: Connaughty Industries, Inc., dba Rushford Manufacturing, Rushford, MN (US)

(21) Appl. No.: 18/412,288

(22) Filed: Jan. 12, 2024

Related U.S. Application Data
(60) Provisional application No. 63/504,673, filed on May 26, 2023.
(60) Provisional application No. 63/576,066, filed on Jan. 12, 2023.

(51) Int. Cl. B23K 37/04; B23K 26/38

(52) U.S. Cl. CPC B23K 37/04; B23K 26/38

(57) ABSTRACT

A system and method that relates to an improved worktable design which facilitates easy replacement of slats on a work surface for a laser cutter. The work surface includes a frame that has a first slat mount and a second slat mount which extend along opposite sides of the frame. The first and the second slat mounts have a plurality of slat supports. A plurality of slat systems each extend from the first slat mount to the second slat mount at a corresponding one of the plurality of slat supports. Each of the plurality of slat systems includes a slat guide with a slat channel, and a slat that is configured to fit within the slat channel. The slat system is removable from the slat mount and the slat is replaceable from the slat system.

### CROSS-REFERENCE TO RELATED APPLICATIONS

This application claims the benefit of U.S. Provisional Application No. 63/504,673, filed on May 26, 2023; and U.S. Provisional Application No. 63/576,066, filed on Jan. 12, 2023, the disclosures of which are hereby incorporated by reference in their entireties. To the extent appropriate, a claim of priority is made to each of the above-disclosed applications.

### BACKGROUND

Laser cutters are advanced fabrication tools that employ a focused, high-powered laser beam to precisely cut, engrave, or etch materials. At a high level, these devices operate by directing the coherent light emitted from a laser tube onto a workpiece using a system of mirrors and lenses. Typically, a CNC system orchestrates the movement of the laser head, guiding it along a designated path according to a digital design file. Laser cutters are favored for their unparalleled accuracy, efficiency, and versatility, as they can process a wide range of materials including wood, plastics, textiles, metals, and more. Their non-contact cutting process minimizes material waste and reduces the risk of damage, making laser cutting an invaluable tool for industries such as manufacturing, architecture, and art.

Slag is a byproduct that can be left behind during the laser cutting process, particularly when cutting metals. It consists of molten material, oxides, and impurities that accumulate along the edges of the cut and on the cutting worktable, forming unwanted rough or uneven surfaces. Slugs are larger cutouts from the laser cutting process which can similarly create rough and uneven surfaces. Excessive slag, slug, and debris buildup can negatively impact the overall quality and appearance of the cut, as well as lead to increased material waste and post-processing work.

Laser cutter worktables typically have slats forming a worktable surface. The slats minimize contact with the workpiece being cut. Cleaning slag from a worktable is a vital maintenance task that ensures optimal performance and prolongs the equipment's lifespan. Over time, however, the slats wear and become deformed through repeated laser contact, slag cleaning, and the loading/unloading of heavy workpieces. Replacement of the slats is regularly necessary in order maintain proper function. In some cases, entire worktables may need to be replaced. The replacement of slats is labor intensive and often requires significant down-time. There is a need for an improved slat design and replacement process.

### SUMMARY

In general terms, this disclosure is directed to a laser cutter work surface. In some embodiments, and by non-limiting example, the laser cutter work surface includes a slat system.

One aspect of the present disclosure relates to a work surface for a laser cutter that includes a frame and a plurality of slat systems. The frame includes a first and a second slat mount that extend along opposite sides of the frame. The first and second slat mounts have a plurality of slat supports. The plurality of slat systems each extend from the first slat mount to the second slat mount at a corresponding one of the plurality of slat supports. Each of the plurality of slat systems includes a slat guide including a slat channel, and a slat configured to fit within the slat channel. In some examples, the work surface includes a securing feature for each of the plurality of slat supports which retains the slat within the slat support. In some examples, the securing feature is a screw. In some examples, the securing feature is configured to break away and allow the slat system to leave the slat support when the slat system is subject to a force that exceeds normal operation. In some examples, the slat mount is integral with the frame. In some examples, the slat mount is removably attached to the frame. In some examples, the slat is a plurality of slats configured to fit within a single slat channel. In some examples, the slat mount includes an angled surface configured to direct debris toward an inner area of the frame.

Another aspect of the present disclosure relates to a slat system for a worktable where the slat system includes a slat guide and a slat. The slat guide extends from a first end to a second end. The slat guide includes a slat channel that extends at least partially between the first end and the second end. The slat is configured to fit partially within the slat channel. In some examples, the slat guide includes tabs at both the first and second ends. The tabs are configured to engage with a corresponding slat support on a work surface frame. In some examples, the slat guide includes first and second guide plates. The first and second guide plates are structurally identical. In some examples, the slat guide further includes a slat spacer. The slat spacer links the first and second guide plates to form the slat channel. In some examples, each of the first and second slat guides include at least one spacer interface, and the slat spacer includes at least one corresponding spacer linkage. The spacer interface of the first slat guide contacts the spacer linkage on a first side of the spacer and the spacer interface of the second slat guide contacts the spacer linkage on a second side of the spacer such that the first slat guide is retained on the first side of the spacer and the second slat guide is retained on the second side of the spacer. In some examples, the spacer interface and spacer linkage form through holes configured for a bolt. In some examples, the slat guide includes at least one slat interface and the slat includes at least one corresponding slat linkage. The slat interface and the slat linkage contact each other to retain the slat within the slat channel. In some examples, the slat interface and the slat linkage form through holes configured for a bolt. In some examples, the slat is a plurality of slats, where the plurality of slats are configured to be sequentially adjacent within the slat channel. In some examples, the slat has a thickness that is approximately equal to the slat channel width.

Another aspect of the present disclosure relates to a method of replacing a slat on a laser cutter worktable. The method includes removing a slat system from a slat mount on the worktable. The slat system is configured to support a workpiece on the worktable. The slat mount is configured to support the slat system along a first and second side of the worktable. The method further includes removing a slat from a slat channel of the slat system, placing a new slat in the slat channel of the slat system, and replacing the slat system into the slat mount. In some examples, the method includes removing a bolt extending through a slat interface after removing a slat system from a slat mount. In some examples the method includes selectively removing any number of a) a slat guide from the slat system; b) the slat mount from the worktable; c) a slat spacer from the slat system; and replacing each of the selectively chosen components.

### BRIEF DESCRIPTION OF THE DRAWINGS

FIG. 1 is perspective view of an example laser cutting assembly in accordance with the principles of the present disclosure.

FIG. 2 is a perspective view of an example worktable in accordance with the principles of the present disclosure.

FIG. 3 is a perspective view of a frame of the worktable in FIG. 2.

FIG. 4 is a perspective view of an example slat mount in accordance with the principles of the present disclosure.

FIG. 5 is a front view of the slat mount of FIG. 4.

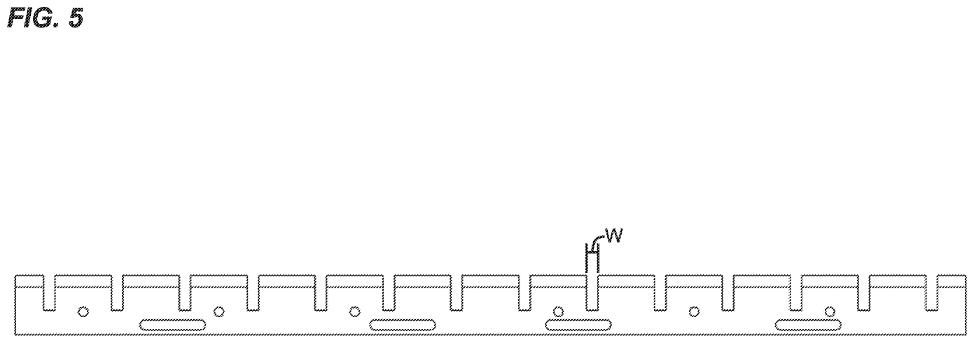

FIG. 6 is a perspective view of an example slat system in accordance with the principles of the present disclosure.

FIG. 7 is a side view of the slat system of FIG. 6.

FIG. 8 is a front view of the slat system of FIG. 6.

FIG. 9 is a perspective view of the slat system of FIG. 6 with one side of a slat guide removed.

FIG. 10 is a side view of the slat guide of the slat system in FIG. 6.

FIG. 11 is a side view of a channel spacer of the slat system in FIG. 6.

FIG. 12 is a perspective view of an example slat in accordance with the principles of the present disclosure.

FIG. 13 is a side view of another example slat in accordance with the principles of the present disclosure.

FIG. 14 is a perspective view of another example slat in accordance with the principles of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

One aspect of the present disclosure relates to an improved worktable design that facilitates easy replacement of slats on the worktable. The improved worktable design disclosed herein is also applicable to other possible applications beyond just laser cutting. For example, additional embodiments of the present disclosure include a worktable for a waterjet cutter, a plasma cutter, a flame cutter, and a welder. For ease of discussion, the disclosure refers to an example application of the worktable for a laser cutter, but the same or similar worktable can also be used for such other applications to form additional embodiments of the present disclosure.

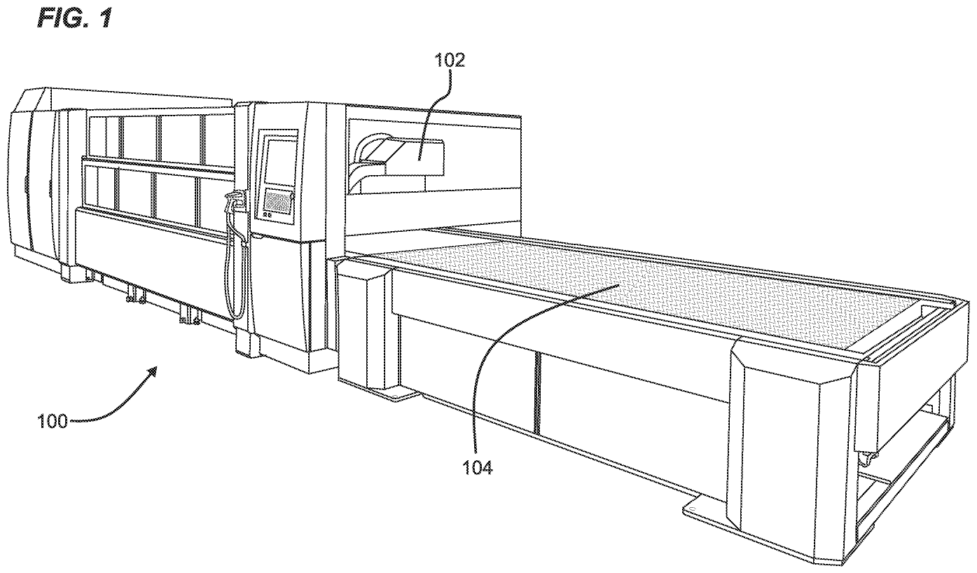

FIG. 1 shows the outside of a typical laser cutting assembly 100 that includes a covering commonly used for improved safety in manufacturing facilities. The example laser cutting assembly 100 of FIG. 1 includes laser cutter 102 and a work surface 104. It should be appreciated, however, that many different laser cutters and work surface designs exist and the inventive aspects of the present disclosure may be adapted to suit any specific laser cutter 102 or work surface 104.

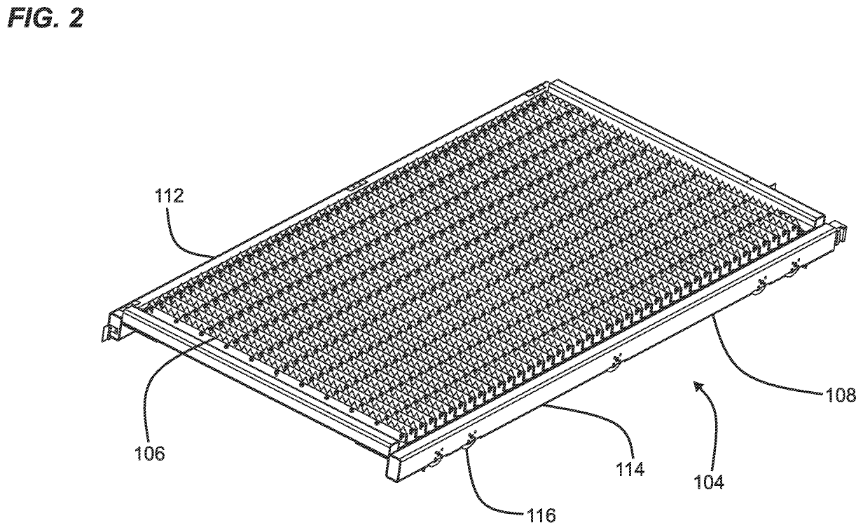

The example work surface 104 in FIG. 2 shows slat systems 106 and a frame 108. The slat systems 106 run in parallel from a first side 112 to a second side 114 of the work surface 104. The work surface 104 may include additional features such as support legs that create a worktable from the work surface 104. Alternatively, as shown in FIG. 2, the work surface 104 may include wheels 116 that can be used to change out work surfaces 104 more quickly or be used as part of a workstream where the work surface 104 travels between stations. By cycling work surfaces 104, laser cutting operations may be expedited. Workpieces can be loaded, unloaded, cleaned, or replaced separate from the laser cutting assembly 100. For example, A plurality of work surfaces 104 may be queued for cutting in a stack, or other configuration, such that as one work surface 104 exits the laser cutter 102, another work surface 104 from the queue may roll into position to be cut. In this way, much of the cutting operation can be automated and repairs can occur in line with the manufacturing process. In one example, two work surfaces 104 rotate between a loading stage and a cutting stage such that, while a part is being cut in the cutting stage, another part can be loaded in the loading stage.

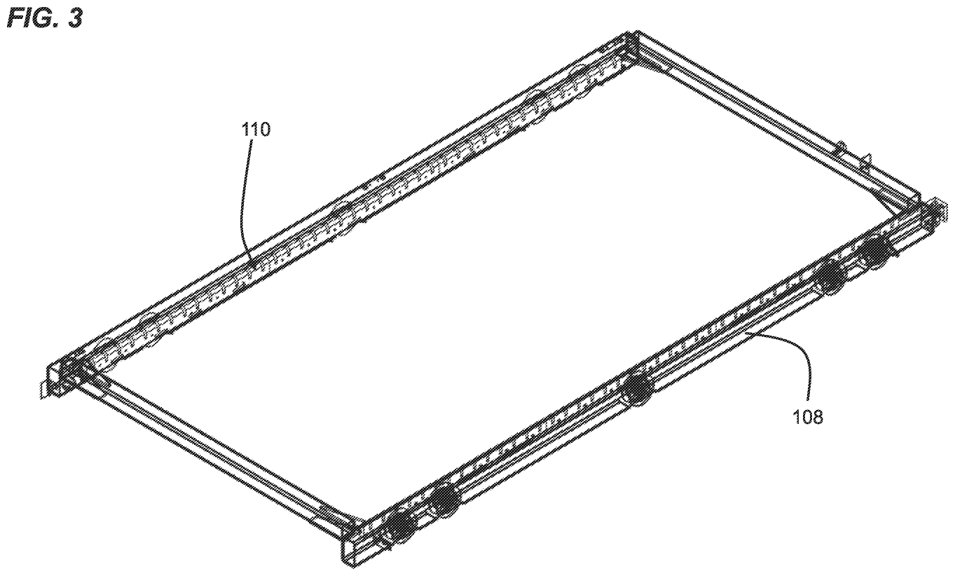

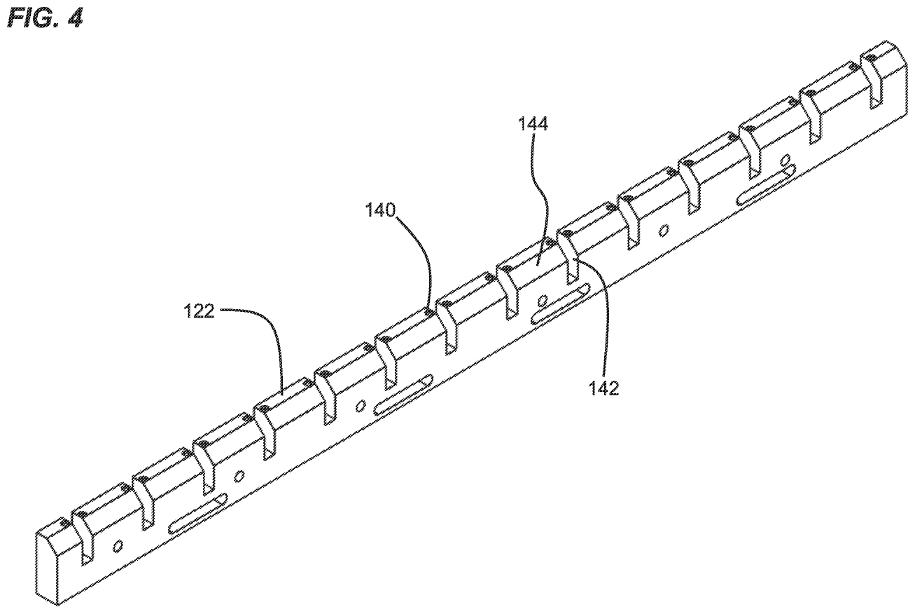

The work surface 104 includes slat systems 106 that run across the work surface 104. The slat systems 106 can attach to the frame 108 of the work surface 104 in any number of ways. Preferably, the slat systems 106 are easily removable from the frame 108. For example, the slat systems 106 could attach to the frame 108 at slat supports 142 with bolts, pins, clamps, cam locks, magnets, slots, etc. The slat systems 106 may attach directly to the frame 108 or to an intermediate component. The attachment region may be referred to as a slat mount 110. The example in FIGS. 3 and 4 show the slat mount 110 as an intermediate component. The slat mount 110 has a plurality of slat supports 142 that are meant to engage the slat systems 106. The example slat mount 110 of FIGS. 3 and 4 connects to the frame 108. When the slat mount 110 is an intermediate component, the slat systems 106 can be implemented on existing frames or work surfaces 104 that do not include slat supports 142. The use of slat mounts 110 also enables easy replacement of parts that can commonly become damaged or filled with slag without the need to replace the entire frame 108.

The slat supports 142, shown in FIG. 4 are regularly spaced slots with an open upper portion. The slat systems 106 may include tabs 128 that seat into the slat supports 142. The slat supports 142 have an opening width W that corresponds to the tab 128 width. The slat supports 142 may have shaped edges to facilitate easy insertion of the slat systems 106. For example, the slat supports 142 may have beveled or rounded edges. The slat mount 110 of FIGS. 3 and 4 further includes an angled surface 144 which helps to direct slag, slugs, and other debris toward the inside of the frame 108 where it can be collected. Debris that falls outside the frame 108 can cause production issues by getting caught in other equipment, creating safety hazards on the ground, or blocking operation of the wheels 116. Many alternative interfaces between the slat system 106 and the slat mount 110 are possible.

The slat mount 110 may also include securing features 140. The securing feature 140 ensures that the slat system 106 is held in place with limited resistance. During loading, unloading, cutting, and cleaning, many forces can be applied to slat 120, 220 and slat system 106. The securing feature 140 resists some of these forces but breaks away or fails at a threshold force. Sometimes during operation, equipment can catch or hang-up on the slat system 106 and, without a break away feature, the entire work surface 104 may be deformed or destroyed. By including a securing feature 140 that resists normal contact forces but breaks away or fails during unintended contact, the frame 108 and other components can be preserved. There are a number of different ways that securing feature 140 may be implemented. For example, securing feature 140 could be a spring, a weighted part, a magnet, a screw, a clamp, or any other means for providing a limited resistance. FIGS. 3 and 4 show one example where a small screw or bolt is used to prevent the slat system 106 from leaving the slat support 142 during normal operation. However, upon a significant hang up, the screw or bolt fails first and allows the slat system 106 to leave the channel, thereby preventing further damage to the work surface 104 or surrounding equipment. In this example, the head of the screw overhangs the slat support 142 such that the tab 128 of the slat system 106 cannot be lifted from the slat support 142 without interfering with the head of the screw. In this example, the securing feature 140 may be incorporated on both sides of slat support 142, such that if one securing feature 140 is damaged the other may be used instead of replacing slat mount 110.

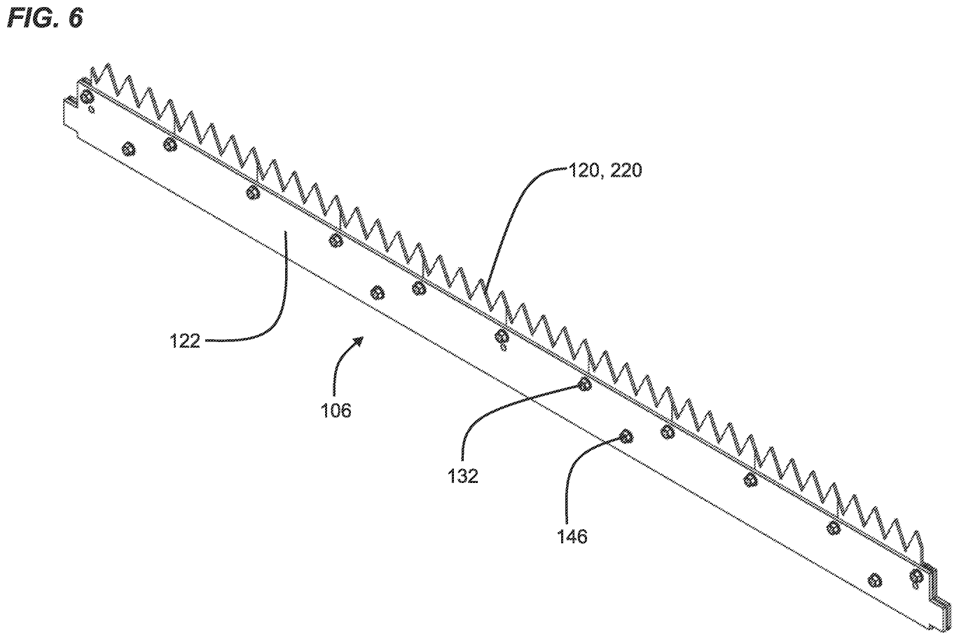

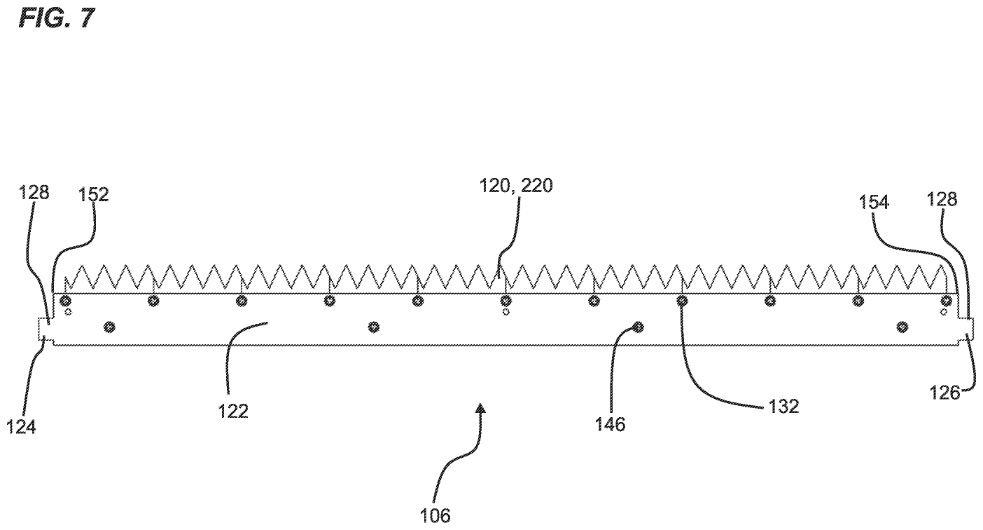

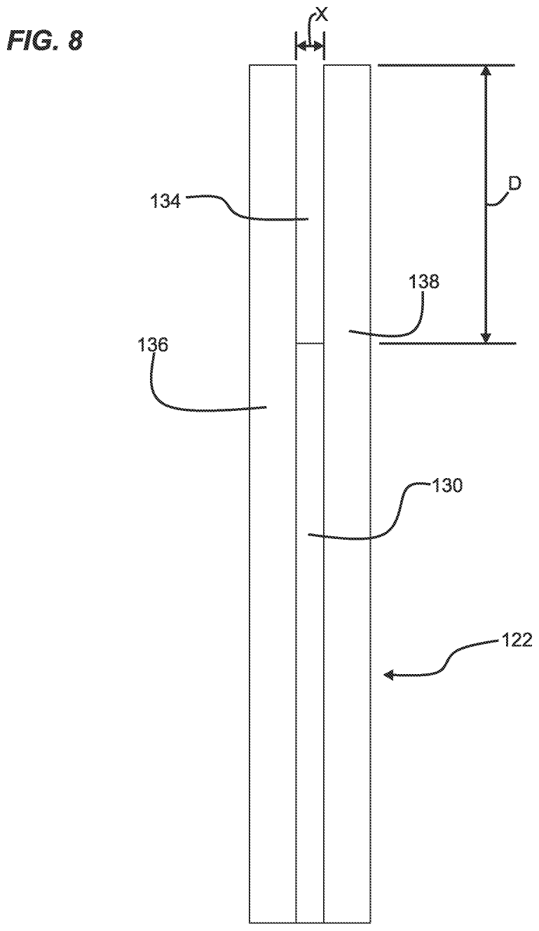

Returning to the slat system 106, FIGS. 6 and 7 show an example slat system 106 as may be used with work surface 104. The slat system 106 extends from a first end 124 to a second end 126. The slat system 106 includes slats 120, 220 and slat guide 122. In other examples, the slat system 106 may include only slats 120. The slat guide 122 provides a slat channel 134 in which the slats 120, 220 seat. The slat channel 134 extends from a first channel end 152 to a second channel end 154. In some examples, the slat channel 134 extends a distance that is less than the distance between the first end 124 and the second end 126. In other examples, the slat channel 134 length may be the same as the slat system 106 length. The slat guide 122 may be of single piece construction or multipiece construction. FIG. 8 shows a side view of a slat guide 122 that is a multipiece construction. The slat guide 122 includes first and second guide plates 136, 138, and a slat spacer 130. The three-piece construction allows for reduced material costs, targeted repairs, and improved slat width tolerance. The slat channel 134 shown in FIG. 8 has a width X that may be nearly equivalent to a slat thickness T, such that when the slat 120, 220 is inserted into the slat channel 134, they form a close fit. The slat channel 134 has a depth D that is less than the height of the slat 120, 220.

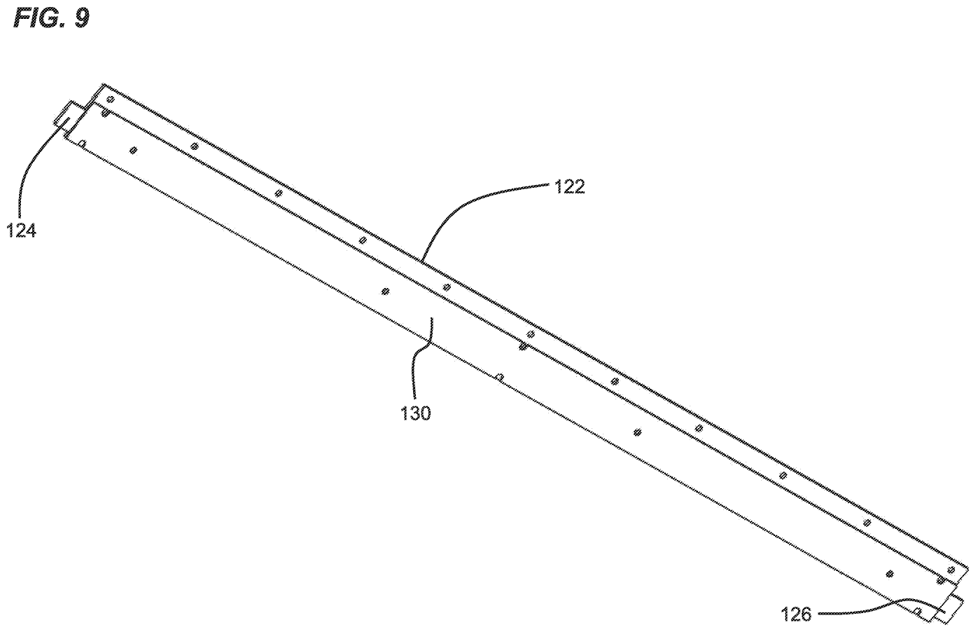

The slat guide 122 increases the stiffness of the slat system 106 such that the slat system 106 can span from the first side 112 to the second side 114 of the frame 108 without the need for additional support beneath the slat system 106. The removal of any additional support material, such as a lattice structure, below the slat system 106 further improves the ability of slag, slugs, and debris to drop down into the desired location below the work surface 104 by removing additional obstacles. FIG. 9 shows a slat guide 122 with second guide plate 138 removed.

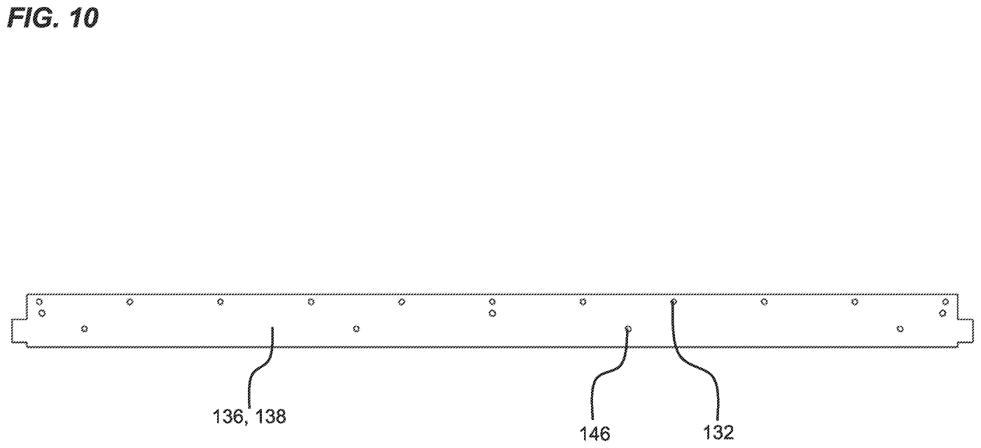

Depending on the configuration of the slat system 106, the tabs 128 may be part of any, or all, of the components making up the slat guide 122. In FIG. 4, the tabs 128 are formed by the first and second guide plates 136, 138. A single guide plate 136, 138 with tabs 128 can be seen in FIG. 10. Alternatively, the tab 128 could be part of the slat spacer 130, part of the slat 120, 220, or another component. Other configurations are possible too. The tab 128 may instead be a shaped joint, notch, hook, or other feature that facilitates connection to the frame 108. The tab 128 may be part of the frame 108 or slat mount 110 that is received by the slat system 106. As previously mentioned, there are numerous ways to connect the slat system 106 to the frame 108.

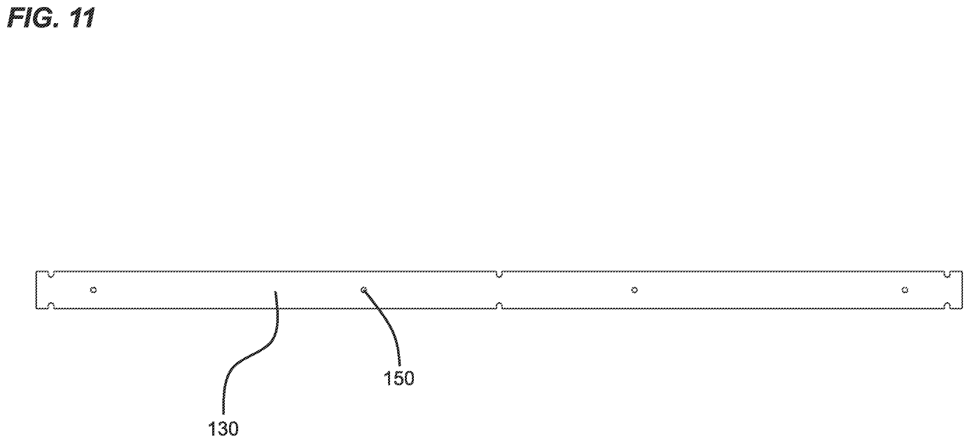

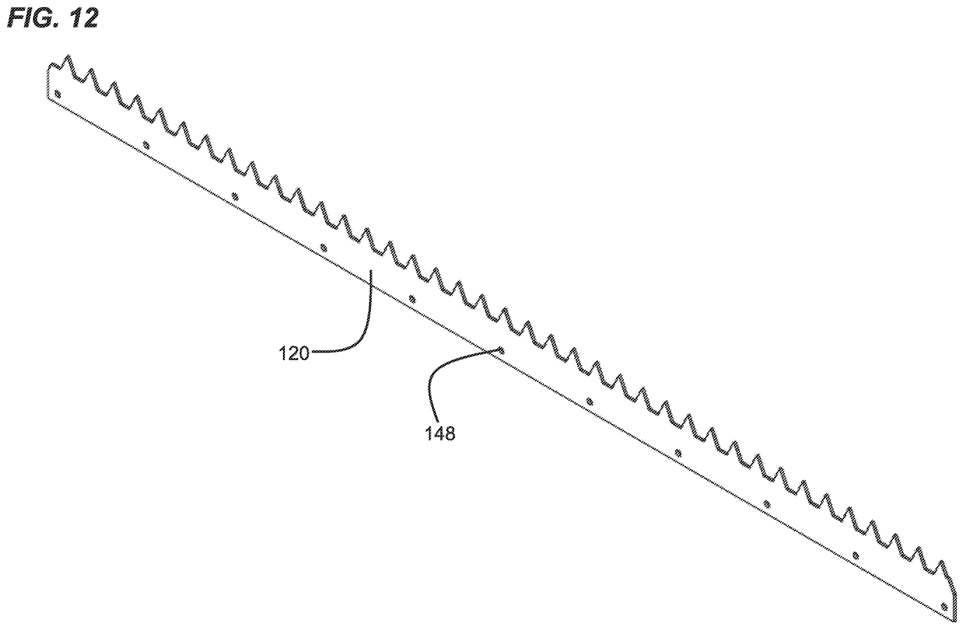

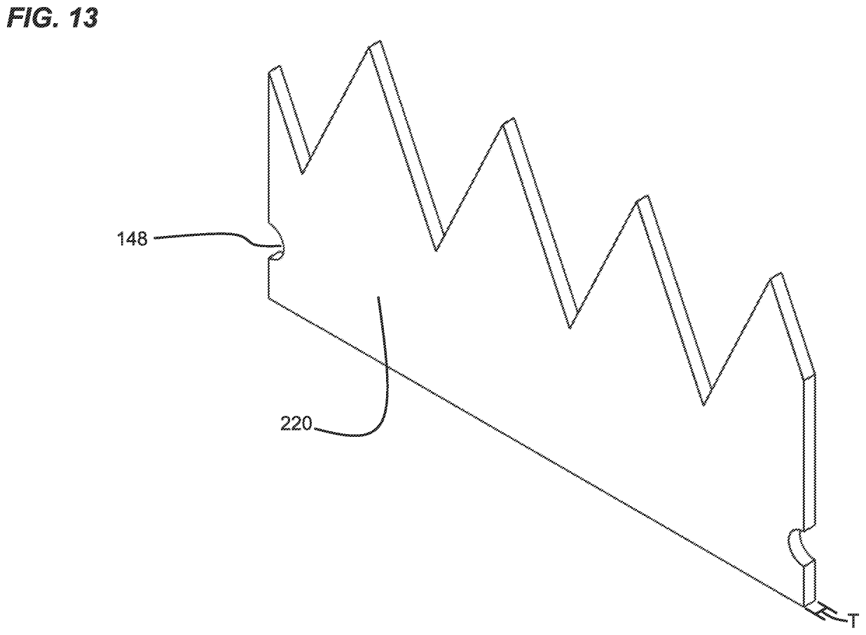

The slat guide 122 may include any number of additional features, such as interfaces for securing the slats 120, 220. Slat interface 132 is shown to secure the slat 120, 220 within the slat channel 134. Securing the slat 120, 220 to the slat channel 134 can be done by any number of means. In FIG. 7, the slat 120, 220 is secured in the slat channel 134 by a small bolt that runs through slat interface 132 of the slat channel 134 and through a slat linkage 148 of the slat 120, 220 (shown in FIGS. 12 and 13). In the multipiece example, shown in FIG. 6, the slat interface 132 may be on either or both the first and second guide plates 136, 138. Similarly, the multipiece example may further include a spacer interface 146. FIG. 10 shows spacer interface 146, which aligns with a spacer linkage 150 shown on FIG. 11. The slat spacer 130 may be linked with the guide plates 136, 138 through any number of means previously described. In FIG. 6, small bolts are shown which travel through the spacer interface 146 and spacer linkage 150.

The slat channel 134 is spaced to accommodate a thickness T of the slat 120, 220. Where a slat spacer 130 is used, the slat spacer 130 may be generally the same thickness as the slat 120, 220. The slat thickness T may vary depending on the desired attributes. A thicker slat 120, 220 may provide greater rigidity which could improve durability but would increase cost. Conversely, a thinner slat 120, 220 may be less durable or only able to support a reduced load but have a cheaper cost. Depending on the frame 108 dimensions, the slat 120, 220 may be thick enough to eliminate the need for other components within the slat system 106 by extending between frame sides 112, 114 without additional support. Commonly slats are made of copper, but other materials and metals may be used.

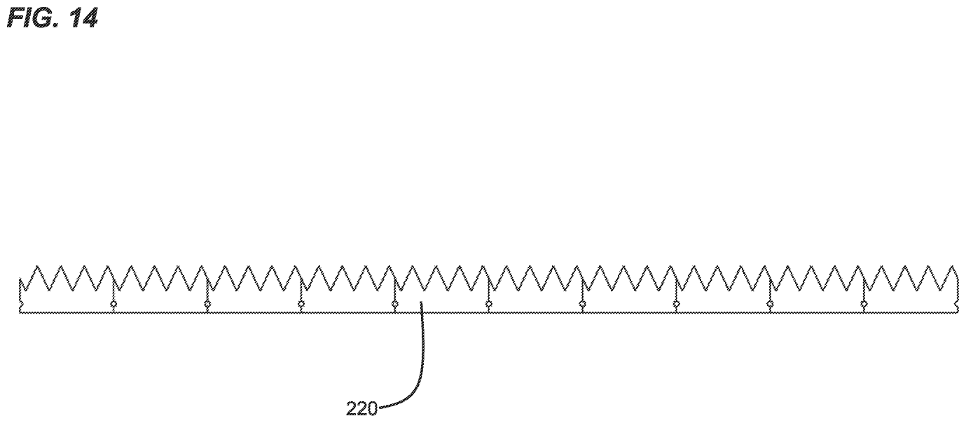

The length of a slat may vary. FIG. 12 shows slat 120 that is intended to span the length of nearly the entire slat channel 134, or at least the entire usable length of the table from first side 112 to second side 114 of the frame 108 (as can be seen in FIG. 2). Alternatively slat 220, shown in FIG. 13, only covers a partial length of the slat system 106 or slat channel 134. Slat 220 can be used in multiples to span the same distance that slat 120 would cover. Slat 220 shows slat linkages 148 at each end such that a slat linkage 148 would exist at the intersection of each slat 220 as they are positioned within the slat channel 134. The slat linkage 148 may be placed in other locations as well. The slat 220 may have different lengths which may change the number and location of the slat linkages 148. For example, slat 220 may be long enough to cross two or more slat interfaces when positioned in the channel. Shorter slats offer the benefit of being able to use smaller pieces of material to create the slat 220. In some cases, material that would otherwise be scrap can be used to form slats. FIG. 14 shows an example of how multiple slats 220 can align to span the length of slat 120. Slat 220 may be adjacent to another slat 220 such that a plurality of slats 220 are sequentially adjacent to each other when held within a slat channel 134. Either slats 120 or slats 220 may be used in the slat systems 106 previously described. A work surface 104 may include both slats 120 and slats 220.

Slats 120,220 may also have different patterns. In some examples, the slats 120, 220 have periodic peaks that are pointed. Many other configurations are possible. For example, the slats 120, 220 may have flat peaks or curved peaks. The frequency may be intermittent instead of periodic. In some examples, the slats 220 are designed to minimize waste when being cut from a large sheet.

Many variations on the work surface 104 previously described are possible. For instance, the securing feature 140 on slat mount 110 may be additionally or alternatively located on the slat system 106. The slat interface 132 may incorporate a securing feature 140, or a securing feature 140 may be added to the slat system 106. Other constructions of the slat system 106 are possible. The slat system 106 may include a multipiece design where slat spacer 130 is integral to the guide plates 136, 138. The slat system 106 may include beveling or rounding on edges to decrease hard contact points and reduce slag buildup.

The slat system 106 described above has many benefits. One being the replaceability of any or all of the components on a selective basis. Slag and debris buildup occurs unevenly on a work surface 104. For example, if a laser cutter 102 frequently cuts the same parts, slag will build up in the areas where cutting regularly occurs much faster than on other parts of the table. Likewise slag buildup and wear may occur on just one side of a slat 120, 220. Selective replacement enables reduced waste. In other examples, it may be desirable to remove certain slat systems 106 from the plurality of slat systems 106 which extend along the work surface 104 in order to create an opening on the work surface 104. The slat systems 106 are easily removed.

Further, the slat system 106 provides the ability to quickly change out slats 120, 220 and other components. For example, the securing feature 140 may be detached from both slat mounts 110 on the first and second sides of the frame 108 and the slat system 106 may be pulled away, or otherwise removed from the work surface 104. Once the slat system 106 is removed from the work surface 104, a new slat system 106 may be inserted. Or, the old slat system 106 may be cleaned, repaired, or replaced. Several different components may be repaired or replaced. For example, the slat 120, 220, slat guide 122, first or second guide plates 136, 138, slat spacer 130, tabs 128, or any other component may be replaced. One common replacement includes the slat 120, 220. The slat 120, 220 may be removed by detaching the slat interface 132 from the slat linkage 148. In one example, the slat interface 132 and slat linkage 148 are detached by removing the bolt running through them and pulling the slat 120, 220 from the slat channel 134. Another common replacement includes the slat guide 122. In the example where first and second guide plates are used, the two may be detached. In one example, this includes removing one or more bolts holding the two together. In the example where a slat spacer 130 is used, the guide plates 136, 138 may be removed by disconnecting the spacer interface 146 and the spacer linkage 150. In one example, the spacer interface 146 and spacer linkage 150 are detached by removing the bolt running through them and pulling the guide plate from the spacer.

One example method of replacing a slat 120, 220 on a laser cutter 102 worktable includes removing a slat system 106 from a slat mount 110 on the worktable. Then removing a slat 120, 220 from the slat system 106. Then replacing the slat guide 122 into the slat mount 110. The method may also include removing a slat system 106 from a slat mount 110 by removing the securing feature 140. The method may further include removing the securing feature 140 where the securing feature 140 is a bolt extending through a slat interface 132. The method may also include replacing the slat system 106 in the slat mount 110 and further replacing the securing feature 140. The method may also include selectively removing any number of a) a slat guide 122 from the slat system 106; b) the slat mount 110 from the worktable; c) a slat spacer 130 from the slat system 106; and replacing each of the selectively chosen components. The method may also include separating the slat linkage 148 and slat interface 132. The method may also include separating the spacer linkage 150 and spacer interface 146. The method may also include rejoining the slat linkage 148 and slat interface 132. The method may also include rejoining the spacer linkage 150 and spacer interface 146.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A work surface for a laser cutter comprising:
a frame including a first slat mount and a second slat mount extending along opposite sides of the frame, the first and the second slat mounts having a plurality of slat supports; and
a plurality of slat systems each extending from the first slat mount to the second slat mount at a corresponding one of the plurality of slat supports, each of the plurality of slat systems comprising:
a slat guide including a slat channel; and
a slat configured to fit within the slat channel.

2. The work surface of claim 1, wherein the first and second slat mounts include a securing feature for each of the plurality of slat supports which retains the slat within the slat support.

3. The work surface of claim 2, wherein the securing feature is a screw.

4. The work surface of claim 2, wherein the securing feature is configured to break away and allow the slat system to leave the slat support when the slat system is subject to a force that exceeds normal operation.

5. The work surface of claim 1, wherein the first and second slat mounts are integral with the frame.

6. The work surface of claim 1, wherein the first and second slat mounts are removably attached to the frame.

7. The work surface of claim 1, wherein the slat is a plurality of slats configured to fit within a single slat channel.

8. The work surface of claim 1, wherein each slat mount includes an angled surface configured to direct debris toward an inner area of the frame.

9. A slat system for a worktable, the slat system comprising:
a slat guide extending from a first end to a second end, the slat guide including a slat channel extending at least partially between the first end and the second end; and
a slat configured to fit partially within a slat channel.

10. The slat system of claim 9, wherein the slat guide includes tabs at both the first and second ends, wherein the tabs are configured to engage with a corresponding slat support on a work surface frame.

11. The slat system of claim 9, wherein the slat guide comprises first and second guide plates, wherein the first and second guide plates are structurally identical.

12. The slat system of claim 11, wherein the slat guide further comprises a slat spacer, wherein the slat spacer links the first and second guide plates to form the slat channel.

13. The slat system of claim 12, wherein each of the first and second slat guides includes at least one spacer interface and the slat spacer includes at least one corresponding spacer linkage, wherein the spacer interface of the first slat guide contacts the spacer linkage on a first side of the slat spacer and the spacer interface of the second slat guide contacts the spacer linkage on a second side of the slat spacer such that the first slat guide is retained on the first side of the slat spacer and the second slat guide is retained on the second side of the slat spacer.

14. The slat system of claim 13, wherein the at least one spacer interface and the at least one spacer linkage form through holes configured for a bolt.

15. The slat system of 9, wherein the slat guide includes at least one slat interface and the slat includes at least one corresponding slat linkage, wherein the slat interface and the slat linkage contact each other to retain the slat within the slat channel.

16. The slat system of claim 15, wherein the at least one slat interface and the at least one slat linkage form through holes configured for a bolt.

17. The slat system of claim 9, wherein the slat is a plurality of slats, wherein the plurality of slats are configured to be sequentially adjacent within the slat channel.

18. The slat system of claim 9, wherein the slat has a thickness that is approximately equal to a width of the slat channel.

19. A method of replacing a slat on a laser cutter worktable, the method comprising:
removing a slat system from a slat mount on the worktable, the slat system being configured to support a workpiece on the worktable, the slat mount being configured to support the slat system along a first side and a second side of the worktable;
removing a slat from a slat channel of the slat system;
placing a new slat in the slat channel of the slat system; and
replacing the slat system into the slat mount.

20. The method of claim 19 further comprising, after removing the slat system from the slat mount, removing a bolt extending through a slat interface.
